(19) United States
(12) Patent Application Publication
(10) Pub. No.: US 2016/0175870 A1
(43) Pub. Date: Jun. 23, 2016

(54) Nozzle Adjustment Aid, and Method

(71) Applicant: CHEMETALL GMBH, Frankfurt am Main (DE)

(72) Inventors: Werner Aporta, Hofheim am Taunus (DE); Axel Schöne, Nidderau (DE)

(21) Appl. No.: 14/910,109

(22) PCT Filed: Aug. 4, 2014
(86) PCT No.: PCT/EP2014/066715

§ 371 Date: Feb. 4, 2016

(30) Foreign Application Priority Data
Aug. 6, 2013 (DE) 10 2013 215 475.5

(51) Int. Cl. B05B 12/12

(52) U.S. Cl. CPC B05B 12/124

(57) ABSTRACT

The invention relates to a nozzle adjustment aid (A) for a liquid spray nozzle (B) for the testing, positioning and/or adjusting of at least one nozzle (B) for spraying operations in surface engineering plants, in which the nozzle adjustment aid (A) has a nozzle adapter (F) and at least two positioned and aligned light sources (H, M) with sharp concentration and/or with focusing, by means of which at least two light beams (J, P) can be generated approximately along the nozzle central line and/or approximately along at least one boundary line at the boundary of the theoretical spray area (C) or approximately along at least two preferably oppositely situated boundary lines, which light beams are substantially intended to indicate the position and size of the theoretical spray area (C). The invention also relates to a method for improving the spraying operation in a surface engineering plant, in which method a nozzle adjustment aid (A) according to the invention is used for the testing, positioning and/or adjustment of at least one nozzle in a surface engineering plant.

The invention relates to a nozzle adjustment aid for a liquid spray nozzle for testing, positioning and/or adjusting a spray nozzle in particular with respect to the direction of spraying and/or the spray angle and a method for improving spraying in a surface engineering plant as well as the use of a surface engineering plant with improved adjustment of nozzles and use of the objects treated in this plant.

When spraying, a liquid stream is directed at an object to be sprayed, a) to wet this object with the liquid as uniformly and as thoroughly as possible and/or b) to wet it only in a certain area, the latter being in particular with objects made of different materials and/or components. The liquid stream may be spread out broadly, focused more sharply and/or may be a spray mist.

Spraying is also known splashing or spritzing in the same manner. In the present patent application, the word “spray” is generally used instead of “spritz,” although the two terms should have the same meaning in the sense of this patent application. However, with some standard terms, such as “spray ring,” there is not a switch to “spritz ring.”

Spraying is used in surface engineering, in particular for cleaning, degreasing, rust removal, pickling, rinsing with water, with an aqueous solution and/or with a liquid containing an organic solvent, for spraying aqueous conversion compositions, anticorrosion solutions, passivating solutions, primers, paints, insulation materials, sealing materials, adhesives and/or their subcomponents.

In surface engineering, the following plants are used in particular as systems for spraying: chamber systems, cycled chamber systems as well as reversing cycled chamber systems with an alternating back-and-forth conveyor chain, through systems such as tunnel systems and/or immersion spray systems, for example. In an immersion spray system, the objects to be treated are sprayed in at least one section of the plant and are immersed in at least one other section of the plant.

The individual spray systems are often located in spray nozzle arrangements such as nozzle rings, spray registers and/or spray rings, for example. Possible types of spray equipment include in particular nozzles of various designs, various sizes and/or various pressure ranges. Nozzles that may be used include in particular flat spray nozzles, scoop nozzles and/or tongue nozzles—e.g., as special forms of flat spray nozzles, full spray nozzles, hollow cone nozzles and/or solid cone nozzles. Solid cone nozzles may create essentially circular or essentially rectangular spray patterns. Flat spray nozzles yield essentially rectangular spray patterns with a great difference in dimensions, depending on the direction. These nozzles are often made of plastic, e.g., based on polyethylene, and/or made of stainless steel, depending on the use conditions. Suitable adapters may optionally have to be selected and/or adjusted for each nozzle.

With a flat spray nozzle, a hollow cone nozzle and/or a solid cone nozzle in particular, it is necessary to have the most accurate possible spray alignment of the flat spray and/or the spray cone and/or the most accurate possible alignment of the angle. Furthermore, it is necessary to monitor the alignment of the stream and the corresponding coverage of the object to be sprayed with the spray range. This may be done when replacing a nozzle, during renewed attachment and/or renewed adjustment, such as after cleaning a nozzle, for example.

When testing and/or adjusting a nozzle, it is usually necessary to shut down the plant, to have all the aerosols and mists vented from the plant and to allow the plant and its atmosphere to cool down before anyone can enter the interior of the plant, optionally while wearing a rubber suit, respiratory protection and goggles, if necessary. This may often take 0.5 to 2 hours, depending on the plant. The nozzles have previously been set approximately without any aids, for example, when cleaning or replacing a nozzle. A precision adjustment is not customary. Inspection of the adjustment and/or optimization of the adjustment of the nozzles is/are carried out in particular with respect to the direction of spraying, adequate wetting of the entire object surface to be sprayed and optionally adequate overlap of the spray range of one nozzle with the spray range of a neighboring nozzle. The adjustment of each nozzle can be checked visually only by approximation and is therefore done with a brief shutdown of the spray pumps, if necessary, and brief spraying of the object to be treated. If several spray nozzle arrangements, such as nozzle rings, spray registers and/or spray rings, for example, are situated in close proximity, one after the other, usually only the first and last spray nozzle arrangements can be evaluated visually and adjusted in a halfway reliable manner but not the spray nozzle arrangements in between without having to wait a lengthy period of time. If nozzles of the first and/or last spray nozzle arrangements are adjusted incorrectly or inadequately, the plant must be shut down again and at least one of the nozzles of the first and/or last spray nozzle arrangement must be inspected and/or adjusted again. In this case, with the pressure of time, there is not always a long enough wait for the plant to be in a condition suitable for entering and for an evaluation by a person skilled in the art because it has occasionally happened that plants were entered prematurely under some circumstances, but this may be objectionable from the standpoint of labor law and may even be objectionable with regard to the results of the evaluation.

With each cleaning of the nozzles and each replacement of a nozzle it is necessary to position and align each nozzle correctly. A nozzle may be adjusted here in the direction of spray, laterally and/or vertically and/or rotated laterally and/or vertically and/or optionally removed and/or added. Spray nozzle arrangements such as nozzle rings, spray registers and/or spray rings, for example, may also be offset laterally and/or vertically and/or rotated laterally and/or vertically and/or optionally removed and/or added.

Spray nozzles are used in the following process steps of surface engineering in particular: in cleaning, degreasing, rust removal, pickling, rinsing with water, with an aqueous solution, for example, a so-called after-rinse solution or a sealing liquid or with a liquid containing an organic solvent, in spraying aqueous conversion compositions, anticorrosion solutions, passivation solutions, primers, paints and/or liquids containing insulation, a sealing material and/or an adhesive, in particular of metallic surfaces, but also in cleaning, degreasing, rinsing with water, with an aqueous solution, for example, a so-called after-rinse solution or a sealing liquid or a liquid containing an organic solvent, in spraying antistatic compositions, metallizing liquids, passivating solutions, primers, paints, liquids containing insulation, a sealing material and/or an adhesive, in particular of plastic surfaces.

Problems and/or less beneficial treatments occur in particular when there is incomplete coverage of the object surface with the spray ranges, for example, so that the spray liquid cannot wet the entire object surface and/or when only certain sections of the object surface are to be sprayed, for example, such as with insulation, sealants and/or adhesives in particular, in many applications, for example, so that with a poor nozzle adjustment, it may happen that the object becomes soiled at unwanted locations and optionally cannot be painted over again, although it is supposed to be painted over there. In this case, undesirably rough surfaces may be the result in the case of a sealant. Furthermore, with all liquids in general, there may be unnecessary consumption of liquid and/or an unnecessarily large number of nozzles and/or nozzle arrangements may be used in a plant.

For example, in alkaline cleaning of a welded automotive body, various degrees of a good cleaning may occur with liquid, pasty and/or dry impurities in particular, such as, for example, cooling lubricants, press oils, other process aids, metal abrasion and/or dust, if the automotive body is not sprayed with the cleaning liquid on all sides to an equal extent and/or if the spray liquid cannot act to essentially the same extent everywhere because then it may happen that parts of the cleaned automotive body are still slightly soiled and therefore are not wetted and coated completely and uniformly everywhere in the subsequent conversion coating. A tunnel is generally used for that treatment of automotive bodies today. Such a tunnel includes cleaning, rinsing with water or with an aqueous solution, optionally acid pickling and then rinsing with water or with an aqueous solution, treating again with a conversion coating composition, for example, based on zinc phosphate or based on silane, rinsing with water or with an aqueous solution and/or optionally additional treatment steps. All these treatments can fundamentally take place while spraying, in which case the spraying is used more often than immersion or as a spray immersion, in which partial spraying and partial immersion are both performed in one plant. In many plants, 1000 to 4500 nozzles are used for this per plant. If a skewed or bad nozzle adjustment is used in at least one of these process steps, a defective product can be prevented only by working with an unnecessarily large quantity of nozzles and/or treatment liquid per automotive body and/or for an unnecessarily long period of time. Then the process either leads to a certain proportion of defective bodies, which must be aftertreated individually in a complicated procedure, usually by hand, and/or an unnecessarily long cycle, to a plurality of unnecessary spray nozzles, spray nozzle arrangements and/or process substeps, to an unnecessary increase in consumption of treatment fluid(s) and/or an unnecessary volume of circulating water, wastewater and contaminated process fluid(s). The cost of reworking, e.g., by polishing the defective body parts after coating, in particular using a cathodic dip coat and/or after coating in particular using a cathodic dip coat or powder coat and at least one additional paint. In the worst production situations, more than one-third or, in rare cases, even more than two-thirds of the painted bodies include at least one location to be reworked. In particular, marks, i.e., unevenness, which is noticeable visually when looking at the paint, for example, orange peel skin, rivulets and/or mapping, and/or in rare cases even resulting in the dissolution of insulation materials, sealing materials and/or adhesives out of the interior of the body, for example, and/or the components that have been joined by insulating, sealing and/or adhesive bonding. Marks may be the result of an uneven conversion coating and/or a partially defective or inadequate conversion layer, for example, because of inadequate adhesion to inadequately cleaned metal surface sections. For example, these marks may occur on one or more than 20 locations on each automotive body. Then they must be reworked in these locations. If the body has been polished down to the bare metal of the automotive body, some of the bodies to be reworked are passed through the continuous tunnel again and guided by steps through cleaning, optionally pickling, then pretreatment with a conversion composition and some rinsing steps and then dried. If the reworking is too extensive, then the entire defective body will be scrapped in rare individual cases.

For example, in the manufacture of aluminum wheels for use in automotive engineering, it may happen that paint inclusions, inadequate corrosion protection, such as that which can be detected in a scratch test and then a salt spray test, inadequate paint adhesion, such as that which can be detected in a cross cutting test, and/or discoloration may occur. These defects occur in particular when the alkaline cleaner solution and/or the acidic pickling solution is/are not applied uniformly enough to the surface of the wheels and allowed to act there. For treating wheels made of an aluminum alloy, the following process sequence is often used in a treatment tunnel in particular: first, alkaline cleaning of the wheels, which have usually been machined thoroughly, then rinsing with water and/or with an aqueous solution, pickling with an acidic aqueous pickling solution, rinsing with water and/or with an aqueous solution, conversion coating with an aqueous conversion composition, rinsing with water and/or with an aqueous solution, optionally conversion coating with a second aqueous conversion composition of a different type and renewed rinsing with water and/or with an aqueous solution, drying in an adhesive water dryer, for example, and at least painting using a powder enamel, for example, a water-based or solvent-based enamel and drying and/or baking. If adhesion of the paint is not adequate, then the coated wheels must be stripped in a solution of a paint stripper, which is usually alkaline, and then sent back to the full treatment process. In the case of metal abrasion inclusions and dust inclusions, the coated wheels are polished by hand and sent back again to the full treatment process. The capacity of the treatment plant that is theoretically possible can be reduced significantly in this way, e.g., by up to 25%.

In particular, defects, for example, discoloration of the glossy surfaces in particular may occur and may lead to the same or similar types of treatment and/or treatment sequence(s).

These problems occasionally constantly result in reworking and/or repeated treatment and there is hardly any plant that works absolutely without defects for more than half a year.

The patent applicant is not aware of any nozzle adjustment aids that are offered for preventing defects in the surface engineering. Instead, for many years, there has been a demand for inspection of nozzles by some simple method for their adjustments and functions and being able to optimize these.

Therefore, there has been the object of proposing auxiliary means and methods, which permit a better or more accurate inspection and adjustment of nozzles and spray conditions. These may help to temporarily or permanently reduce the number of defects and thus lead to savings in terms of fluids, wastes, manual machining and/or repeated treatments. These auxiliary means or methods should be as simple and robust as possible as well as being adequately precise and usable with the least possible amount of time, because if more time is involved it can result in a production failure.

It has now been found that it is good, sufficiently precise and readily possible to optimize the spray range of spray nozzles using a nozzle adjustment aid according to the invention, which is equipped with at least two laser pointers or with at least other light sources which emit sharply bundled or focused light. Laser pointers here have the advantage that like other light sources, they can also penetrate well through aerosols and mists. The spray nozzles here can be adjusted with sufficient accuracy at the object to be sprayed such as vehicle bodies, for example, in a pretreatment plant. It would be advantageous if an auxiliary means that is not too large and not too heavy for use in such a plant and will tolerate rough working conditions could be proposed.

It has now been found that in many plants and application cases approximately one third and in some cases even approximately one-half of the time for maintenance including inspection and adjustment of the nozzles can be saved with a nozzle adjustment aid according to the invention. It has now also been found that in many plants approx. 10% of the nozzles can be eliminated if all the nozzles are adjusted optimally. It has also now been found that a substantial amount of circulating water, wastewater and process liquids can also be saved. Therefore, substantial savings and improvements can be achieved due to better possibilities of inspection and adjustment of the nozzles. Prespraying and overspraying can now be minimized or even prevented entirely.

This object is achieved with a nozzle adjustment aid A for a liquid spray nozzle B for testing, positioning and/or adjusting at least one nozzle B for spraying in surface engineering plants, characterized in that the nozzle adjustment aid A comprises one nozzle adapter F and at least two positioned and aligned light sources H and/or M with sharp bundling and/or with focusing, with the help of which at least two beams of light J and/or P can be created approximately along the nozzle midline D and/or approximately along at least one boundary line R at the edge of the theoretical spray range C and/or approximately along at least two boundary lines R, preferably opposite lines, which should indicate essentially the position and size of the theoretical spray range C, which can be visible in light spots on the object surface, on hangers, on conveyor facilities and/or on the walls in the plants, so that the angle formed by the beams of light J and/or P corresponds approximately to the half or whole theoretical spray angle N, O and that the beams of light J and/or P are drawn in an at least essentially centrosymmetrical section through the theoretical spray range C. The middle beams of light J, P, the midline of the nozzle D and the boundary lines R preferably intersect approximately at a point on the axis, which runs at a right angle through the central point Z. The mirror plane G preferably intersects this axis approximately there.

The nozzle adjustment aid according to the invention is preferably a handheld device. The nozzle adjustment aid according to the invention is preferably a handheld device that is suitable for variable use conditions and is optionally also suitable for rugged use conditions and/or makes it possible to inspect and adjust a wide variety of nozzles, such as flat spray nozzles, square nozzles, hollow cone nozzles, solid cone nozzles and nozzles with special shapes.

The nozzle adjustment aid according to the invention is preferably a handheld device. It is preferably also characterized in that it consists essentially of a base plate E, a nozzle adapter F and at least two light source adapters HA and/or MA in particular each having a light source H and/or M each light source adapter and optionally also at least one abutment Q having at least one light source adapter HA with at least one light source H on the top side and/or on the bottom side of the base plate E approximately at the level of or parallel to the mirror plane G.

The nozzle adjustment aid according to the invention preferably consists of a base plate E, a nozzle adapter F, at least two light source adapters HA and/or MA, in particular one light source H or M per light source adapter, construction aids such as threads, nuts, screws and/or positioning aids, such as, for example, by means of stops, recesses, boreholes, locking pins, notches, grooves and/or catch positions and optionally also at least one abutment Q having at least one light source adapter HA with at least one light source H on the top side of the base plate E and/or on the bottom side, approximately in the plane of or parallel to the mirror plane G.

The nozzle adjustment aid here with the nozzle adapter F is preferably designed in such a way that the nozzle adapter F can be replaced as needed with at least one other nozzle adapter F, in particular with a nozzle adapter of a different size and/or design shape. The nozzle adjustment aid with the nozzle adapter F is preferably also designed so that the nozzle adapter F can be mounted approximately at the nozzle midline D of the nozzle adjustment aid when replaced by another nozzle adapter F. Nozzle adjustment aids and nozzle adapters F are preferably aligned and positioned, so that the central point of the spray angle of the nozzle corresponds approximately to the central point Z of the of the nozzle adjustment aid.

The light source adapters HA of the light sources of the first type H are preferably designed so that they are situated approximately at the level of the mirror plane G and/or coincide approximately with the nozzle midline D in their alignment. They can preferably be mounted on the base plate E of the nozzle adjustment aid at a certain location and dismantled again as needed.

At least one light source adapter MA of the light sources of the second type M is preferably designed so that it can be offset either continuously or in certain angle intervals in an arc segment around the central point Z, for example.

The nozzle adjustment aid according to the invention can basically be used for all types of nozzles and nozzle arrangement in all types of chamber plants, cycled chamber plants and tunnel plants. At least two, at least four, at least six or at least eight nozzle adjustment aids are preferably used here at the same time to be able to work in a suitable, convenient and/or time-saving manner because with the simultaneous use of a plurality of nozzle adjustment aids, it is possible to work much more economically, and overlap regions can be monitored better and more easily.

‘The nozzle adjustment aid according to the invention may also be used in existing plants for selecting the correct nozzle angles, taking into account the distance from the nozzle opening to the object surface. For example, if the size of the object acted upon should change, it may also be necessary to adjust the instillation angle, the alignment and/or the position of the nozzle and/or to select a different and more suitable nozzle. Since the application region=actual spray range changes with the distance from the nozzle to the object surface, this inspection, change and/or adjustment is readily possible with at least one nozzle adjustment aid. At low pressures, the spray jet may drop slightly due to the force of gravity and the entrained air so that the actual spray range may be smaller and/or may be offset downward, for example, in comparison with the theoretical spray range. The theoretical spray range is determined in particular by the nozzle design shape, position and alignment of the nozzle. Standard data for the various nozzles is usually available in the form of tables. The distance between the theoretical spray range and the actual spray range can often be disregarded if working with a sufficient overlap of spray ranges of neighboring nozzles. If a larger range is to be covered than that which can be reached with just one nozzle, then at least two nozzles must be used, so that their actual spray ranges overlap at least in part.

At least two beams of light J, P can be created with the at least two light sources H, M and at least two light spots representing at least one boundary line R and/or at least one boundary point on the edge of the theoretical spray range C and optionally also the nozzle midline D in a planar and optionally essentially centrosymmetrical section through the theoretical spray range C.

The midline D of the nozzle usually indicates the direction and/or the range of the highest spray pressure. Nevertheless, a declining spray pressure often has no effect on the quality of the treatment because it is mainly the uniform wetting of the surface with the respective liquid and an adequate duration of wetting that are most important. Therefore, well-wetted object surfaces are usually sufficient, in which case the spray nozzles have optimized adjustments and the neighboring spray ranges C overlap somewhat to permit a uniform treatment over the entire wetted object surface.

In many embodiment variants, it is sufficient to create two beams of light P and P essentially in one plane through the midline D of the nozzle, for example, at the right and left of the midline D of the nozzle with two light sources of the second type M and M, which in turn cause two spots of light to become visible on a surface opposite one of the nozzles, representing at least approximately the boundary points of the theoretical spray range C in an planar and essentially centrosymmetrical section through the theoretical spray range C. If necessary, one light source of the first type H is used for approximate representation of the midline D of the nozzle with one beam of light J.

The smaller the light source adapters and the light sources, the more light source adapters and light sources may be affixed simultaneously on one nozzle adjustment aid A and the more it is possible to illuminate total angles O of different sizes and thus spray ranges C of the different sizes, for example, in alternation, by beams of light P. In individual embodiments of the nozzle adjustment aid according to the invention, the light source adapters with the light sources are preferably so small that more than two of them can be affixed simultaneously to the base plate E of the nozzle adjustment aid. The nozzle adjustment aid A may comprise, in addition to the base plate E and the nozzle adapter F, a total of 3, 4, 5, 6, 7, 8 or 9 light source adapters with light sources, which are either only light sources of the second type M or one light source of the first type H and a plurality of light sources of the second type M. The light source adapters and light sources of the second type M here are preferably arranged in pairs for representation of different total angles O and optionally the midline D of the nozzle.

With the nozzle adjustment aid according to the invention, the light source adapters with the light sources of the second type M are preferably arranged in pairs to permit illumination of various total angles O without requiring mounting work. In several preferred embodiments, the light source adapters of the light sources H, M may be mounted in approximate mirror symmetry around the nozzle midline D, the mirror plane G and/or the central beam of light J of the light source of the first type H.

The light source adapters of the light sources H, M are preferably mounted, positioned and aligned at certain angle adjustments by means of conventional construction aids such as threads, nuts, screws and/or positioning aids, for example, such as stops, recesses, boreholes, fixation pins, notches, grooves and/or catch positions on a base plate E.

In several preferred embodiments, the light source adapters of light sources H, M may be arranged and secured essentially in mirror symmetry around the nozzle midline D, the mirror plane G and/or the central beam of light J of the light source of the first type H.

In preferred embodiments, the light source adapters of the light sources H, M may be mounted over at least one first coaxial recess in the base plate E in comparison with the coaxial arrangement of boreholes, positioning aids, aids for angle alignment and/or at least one second recess in the base plate E to be able to adjust the light sources H, M as continuously as possible at angles N, O of various sizes, wherein the axis for the coaxial means runs essentially perpendicular to the base plate E through the central point Z and/or in the mirror plane G.

Alternatively or additionally, it is also possible for a rigid carrier to be mounted on at least one of the light source adapters to make an angle adjustment and accurate alignment by the fact that the end of the rigid carrier is secured at a central location of the nozzle adapter F and/or nozzle B at the point of intersection of all angles N, M, which preferably coincides with the central point Z.

The present invention will now be explained by an example based on the following drawing:

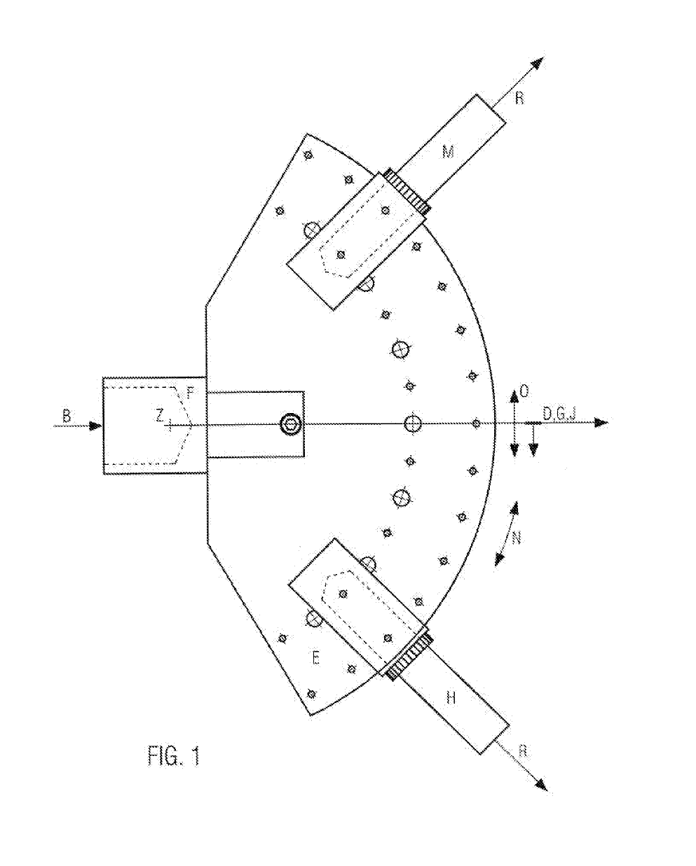

FIG. 1 shows as an example a nozzle adjustment A, which comprises a total of two light source adapters MA with two light sources of the second type M in addition to the base plate E and the nozzle adapter F. The light source adapters HA with a light source of the first type H and additional details are not shown here. The light sources here are preferably laser pointers. The light sources may be secured by bayonet closures, wing nuts, winged screws and/or tension rings, for example. The positioning and alignment of the light source adapters and thus also of the light sources preferably take place here by way of boreholes, fixation pins and recesses, with which the fixation pins can engage. A nozzle B can be inserted from the left into the receptacle opening (not shown) in the nozzle adapter F of a corresponding design and secured there.

### LIST OF REFERENCE NUMERALS

Nozzle adjustment aid A
Nozzle B as a liquid spray nozzle
Spray range C
Nozzle midline D
Base plate E
Nozzle adapter F
Mirror plane G
Light source of the first type H
Height I of the middle beam of light J of a light source above the base plate E
Central beam of light J of the light source of the first type H or of the second type M
Height K of the nozzle midline D above the base plate E
Plane L of the base plate E
Light source of the second type M
Light source adapter HA and MA
Half angle N
Total angle O
Middle beam of light P of a light source of the second type M
Abutment Q perpendicular to the base plate E with at least one additional light source adapter MA
Boundary line R at the edge of the theoretical spray range C
Central point Z

A particularly preferred embodiment of the nozzle adjustment aid is described first below, as it is illustrated as an example in one embodiment variant in FIG. 1:

The nozzle adjustment aid A according to the invention is preferably designed and attached to the respective nozzle B for testing and/or adjustment of the nozzle B, thus forming an essentially centrosymmetric arrangement for the beams of light J and/or P of the light sources H and M or H and H or H and M and H of the nozzle adjustment aid A, for example, coinciding at least approximately with the essentially centrosymmetrical arrangement of the nozzle B and of the spray range C with the nozzle midline D. It is assumed that the nozzle midline D usually represents the midline of the spray range C, which should also be largely consistent with actual practice in geometrically satisfactory and clean nozzles. The flat base plate E, which can be manufactured from sheet metal or a plastic plate, for example, preferably has an approximately mirror-symmetrical base shape. A nozzle adapter F for a nozzle B can be mounted on one side or secured in any conventional manner. To do so, the nozzle B is inserted into a receptacle opening (not shown in detail) in the nozzle adapter F and secured there. The nozzle adapter F is preferably designed so that it is suitable for connection of at least one certain nozzle B. The nozzle adapter F is prepared so that it is mounted centrally on the mirror plane G of the nozzle adjustment aid A, wherein the mirror plane G preferably stands at a right angle to the plane of the base plate E and preferably also coincides at least approximately with the nozzle center line D and in the remaining course also with the central beam of light J of the light source of the first type H. The nozzle adapter F may be adapted in any way to the type, size and shape of the nozzle, or it may be replaced, if necessary. It may optionally be designed so that it has a quick-release device or some other fixation device that can be operated easily and quickly for fixation of the nozzle. A light source of the first type H can be affixed as needed to the base plate E in the mirror plane G and in the direction of the nozzle midline D. The nozzle adapter F and the light source adapter HA and/or MA, which secure the light sources of the first type H and/or of the second type M on the base plate E in their position and their angle in relation to the nozzle midline, preferably do not belong to the base plate in one piece, so that replacement of nozzle adapters F can take place, depending on the design of the nozzle B to be tested and/or adjusted, and thus the light source adapter with the light sources can be offset to form half angles N and/or total angles O of different sizes, for example, wherein the latter should approximately characterize the spray range C. The nozzle adapters F and the light source adapters, for example, may be made of metal or plastic and may be manufactured from blocks, for example. Commercial elements and/or in-house designs may be used as the light sources, preferably those that have small dimensions and are capable of being battery operated in order to be able to work without electric wires. Each light source adapter is designed in a suitable way, so that it can receive a light source, for example, through a suitable receptacle opening, in which the light source can then be aligned and secured. Basically, any light source capable of emitting sharply bundled or focused light in a suitable design and size is suitable as the light source, such as a small laser pointer, for example. The nozzle adapter F and optionally also the light source adapters are preferably not mounted permanently but instead are mounted by means of an adhesive method, a soldering method and/or a mechanical fastening method that is easy and simple to release and simple to affix by means of conventional construction aids, such as threads, nuts and/or screws and/or positioning aids such as stops, recesses, boreholes, mounting pins, notches, grooves and/or catch positions, for example, to receive the protruding sections of fixation pins, which permit positioning and alignment of the nozzle adapter F and/or of the light source adapter as needed. For positioning and alignment of the light source adapters and thus the light sources, for example, boreholes and/or receptacles for the aforementioned sections of the fixation pins may thus be used, permitting easy adjustment and use of half angles N and/or total angles O of various sizes. With appropriate preparation, these boreholes and/or receptacles may be suitable for forming half-angles N of, for example, 5°, 10°, 15° or 20° on up with light source adapters and light sources for some or all angles that are larger by 5°, 10° or 20°, for example, up to 60° or 80°, for example, which are bordered by beams of light J and P. With corresponding preparation, these boreholes and/or receptacles may be suitable for forming total angles O of 10° or 20° for some or all angles with light source adapters and light sources that are larger by 5°, 10°, 15° or 20°, for example, up to 120° or 160°, for example, which are bordered by beams of light P and P.

The light source adapter of each light source H, M is preferably designed and secured together with each light source so that the height I of the middle beam of light J, P of each light source above the base plate E is essentially identical to the height K of the nozzle midline D over the base plate E. Preferably all the central beams of light J, P of the light sources and the nozzle midline D run approximately in a plane parallel or essentially parallel to the plane L of the base plate E and preferably running through the central point Z. At least one light source of the second type M can be affixed as needed to the base plate E in a defined angle laterally to the direction of the mirror plane G. When more than one light source of the second type M is affixed to the base plate E, they are preferably affixed in pairs. It is preferable here to select and adjust at least one light source of the second type M at the left and at least one light source of the second type M at the right of the nozzle midline D, the mirror plane G and the central beam of light J of the light source of the first type H, each with approximately the same half angles N to the left and right.

In a first embodiment variant, two light sources of the second type M are affixed to the left and to the right laterally of the nozzle midline. If necessary, a light source of the first type H may additionally be affixed. In a second embodiment variant, a light source H [sic; M] of the second type is affixed together with a light source D [sic; H] of the first type. Therefore, the half angles N and/or the total angles O are taken into account, preferably being adjusted according to the theoretical spray angle to values of multiples of 5° or 10°, for example.

Particular embodiment variants include the following, for example:

1) The nozzle adjustment aid A comprises, in addition to the base plate E and the nozzle adapter F, a total of 2, 3, 4, 5, 6, 7, 8 or 9 light source adapters with light sources, which are either only light sources of the second type M or they are the one light source of the first type H and at least one light source of the second type M. The smaller the light source adapters and the light sources, the more light source adapters and light sources can be affixed to a nozzle adjustment aid A at the same time, and the more total angles O of different sizes and thus spray ranges C of different sizes can be illuminated, for example, in alternation or simultaneously by beams of light P. Preferably only individual ones of the numerous light sources M are used during operation in one cycle. If all the spray nozzle angles O used in a plant with fixed light sources M are present here, then one may need to change the nozzle adapter F, only in case of a need to adapt it to another nozzle. If the one fixed nozzle adapter F is the only one needed for this plant, this also eliminates replacement of the nozzle adapter F. In these cases, it may be worthwhile to affix a plurality or all of the adapters F, HA, HM on the base plate E for the duration or to design them in one piece or in two pieces with it.

2) Just like or almost like the previous embodiment variants, with this nozzle adjustment aid A, a plurality of light source adapters with light sources may also be used in addition to the base plate E and the nozzle adapter F, in particular for the case when intermediate angle values are needed or the light source adapters, which are used in pairs in particular, are to be adjusted with a smaller number of light sources, but easily and in a flexible manner, a row of boreholes over a longer recess, for example, which is arranged coaxially around an axis perpendicular to the base plate E and through the central point Z, and optionally over a second, longer recess which is arranged coaxially, and which, in comparison with the previous embodiments, can replace a row of boreholes or receptacles or other aids for angle alignment such as notches, grooves, stops, catch positions, etc. It is possible in this way to create a nozzle adjustment aid A that can be used easily, quickly and in a flexible manner. Alternatively or additionally, it is also possible to mount a rigid carrier on at least one of the light source adapters to make an angle adjustment and an accurate alignment by affixing the end of the rigid carrier at a central location on the nozzle adapter F and/or the nozzle B at the point of intersection of all the angles N, M, which preferably coincide with the central point Z.

3) The previous embodiments of the nozzle adjustment aid A have proven excellently successful for testing and adjusting nozzles when the spray range C is essentially conical with cross-sectional diameters that are approximately constant radially or in a transitional form between essentially conical to essentially pyramid shaped with approximately square cross section. In a third special embodiment, of the nozzle adjustment aid A which may be designed exactly or approximately as in the previous embodiment variants, all the essential elements of the previous embodiment variants may optionally be present. In addition, it may be of interest in particular for testing and adjusting flat spray nozzles to equip the nozzle adjustment aid A so that it has at least one abutment Q, preferably approximately perpendicular to the base plate E, approximately in the plane of the mirror plane G or parallel to it, this abutment being designed, so that it has at least one light source adapter with a light source on the top and/or bottom of the base plate E. This abutment Q may correspond essentially or partially to the base plate E and its abutments as needed. The light source adapter here with the light source of the first type H may be omitted, if needed, if the light source adapters with the light sources are used on both the top side and the bottom side. It is preferable here to use a total of four to 20 light source adapters with light sources. It is thus possible to indicate a spray range C approximately with beams of light and/or light spots, which have different longitudinal extents in the two main directions.

For example, a single maintenance of an automotive coating plant with a total of 10 to 14 baths, for example, with nozzles, such that each bath has 20 to 40 nozzle holders each with eight nozzles, for example, which may have to be maintained one to four times each month, usually requiring approx. 1 to 2 hours per bath per maintenance with cleaning and testing and approx. 10 to 24 hours per plant without nozzle adjustment aids if all the nozzles are replaced, cleaned and/or adjusted approximately. Using at least two nozzle adjustment aids according to the invention, this replacement and/or adjustment of the nozzles may take approx. 6 to 16 hours. The use of at least two nozzle adjustment aids according to the invention is helpful to be able to verify and optimize overcoverage of spray ranges. In comfortable maintenance situations, preferably two, approximately four or six or eight nozzle adjustment aids may be used to enable inspection and/or maintenance of preferably the entire spray nozzle arrangement with the least possible effort, so that the time consumed can be further reduced in comparison with inspection and/or adjustment with only two nozzle adjustment aids. If it is possible to save, for example, 8 hours of maintenance time, then production by such a plant can be increased by approx. 80 to 120 vehicles under some circumstances.

Furthermore, the nozzle adjustments in the normal case can no longer be inspected subsequently or readjusted after adjustment of nozzles with the help of the nozzle adjustment aid according to the invention but instead will remain unchanged until the next maintenance. Therefore, a compound advantage is achieved not only due to shorter maintenance times but also due to the elimination of additional inspection and adjustment times and due to a much better quality of the spraying and treatment results.

With regular use of nozzle adjustment aids, it is also possible to significantly reduce the number of nozzles used, the amount of process fluid(s) used, the amount of excess process fluid(s) depending on the spray nozzle arrangement and their positions (equal prespray and/or overspray) such as cleaning stages, pretreatment stages and rinsing stages, to reduce the unnecessary amount of excess process fluid in the process as well as the amount of wastewater, the number of rejects and the extent of manual reworking and/or repeated treatments. Furthermore, unnecessary production down time in the respective plant is eliminated due to the shorter maintenance work. Personnel costs, the cost of materials and the cost of disposal are also thereby reduced accordingly. In many plants it is possible to eliminate even up to approx. 15% of the nozzles and possibly also the nozzle arrangements because, in case of doubt, it is common to use too many nozzles which the have an inadequate effect because of bad adjustments. If there are several plants of a similar design, it may be sufficient to perform an optimized adjustment of the nozzles of the first plant in detail using the nozzle adjustment aid according to the invention and then to transfer the experience thereby gained to the second plant.

This object is also achieved with a method for improving the spraying in a surface engineering plant, which is characterized in that a nozzle adjustment aid A according to at least one of the product claims is used for testing, positioning and/or adjusting at least one liquid spray nozzle B in a surface engineering plant.

The method according to the invention is characterized in particular in that it yields significant improvements in the nozzle midline D, the distance from the nozzle opening to the object surface, the theoretical spray range C, the actual spray range on sprayed object surfaces, the half angle N emanating laterally from the nozzle midline D, the total angle O between at least two beams of light J, P, preferably situated opposite one another and/or the overlap of the spray range of a first nozzle with the spray range of at least one other nozzle and it yields these improvements in testing, positioning and/or adjusting at least one nozzle B and/or at least one nozzle holder having at least one nozzle B.

This object is also achieved with the use of a surface engineering plant having nozzles B and/or at least one nozzle holder having at least one nozzle B, which is adjusted with the nozzle adjustment aid A in a manner that is at least partially improved.

Finally, this object is achieved with the objects that are coated and then treated further in a surface engineering plant using nozzles B that are adjusted by this method, which is at least partially improved, and/or with products produced according to the process claims in automotive engineering, as architectural elements in construction or for manufacturing equipment and machinery, such as electrotechnical devices or household appliances.

### Examples and Comparative Examples

A) Test in a tunnel pretreatment plant for passenger vehicle bodies:

Before optimization of the nozzle adjustment with a nozzle adjustment aid according to the invention in a tunnel pretreatment plant for automotive bodies, it had been impossible to apply adequately closed and adequately uniform and uniformly thick zinc phosphate layers everywhere in the automotive interior and specifically in the roof region, which would lead to reduced corrosion protection in this region due to the fact that the nozzles were adjusted only approximately, and this would amount to a serious quality deficiency in approx. 30% of the vehicles produced.

After optimization of one half of the nozzles with at least one nozzle adjustment aid according to the invention, the phosphate layers formed were almost always designed to be closed and uniform everywhere and to have a significantly higher weight of the layer in previous problem areas than before. This therefore amounted to a significant improvement in corrosion protection, for example, in the roof region because of the optimized nozzle adjustment. The required quality of the corrosion protection was ensured in at least 95% of the vehicles produced or even definitely on each vehicle without reworking.

B) Test in a tunnel pretreatment plant for automotive bodies for transport vehicles

In spraying automotive tailgates, which have a sharply dropping rear end in comparison with the roof in a tunnel pretreatment plant for automotive bodies for transport vehicles, it was found that because of nozzle adjustments that were definitely skewed, the rear end region would not be wetted completely with a rinse water containing a surfactant when the nozzles were not adjusted well. Because of that, these surface regions would have elevated marks with runners, so-called rivulets and/or mapping, i.e., plastic marks similar to those on a map after being coated by cathodic dip coating, and all of these defects were clearly recognizable even after application of the filler and the top coat, when viewed from the side. Before optimization of the nozzles with a nozzle adjustment aid according to the invention, marks could be found in one or more locations on the vehicle, so that all of these locations usually had to be treated in a complicated procedure by polishing and then coating again, optionally with a pretreatment and with multiple layers of paint.

Because of the optimal alignment of the mist nozzles with at least one nozzle adjustment aid according to the invention, this has prevented the elevated marks with a rivulet and the mapping caused by this poor wetting with rinse water containing a surfactant. After optimization of the mist nozzles with at least one nozzle adjustment aid according to the invention, the percentage of vehicles with spots to be polished out due to marks on the vehicle amounted to only approx. 5%.

C) Tunnel pretreatment plant for aluminum wheels

In the production of enameled aluminum wheels, so-called runners from the screw holes occurred in the water rinsing step because of poor nozzle adjustment in a tunnel pretreatment plant because a strongly acidic liquid was left standing in the screw holes, causing a white discoloration and a marked pickling effect. Due to the pickling effect on surfaces that had been turned previously to a gloss, white striations or cloudy discolorations occurred on surfaces, resulting in the need for renewed turning to remove the gloss then pretreatment and painting of the affected areas for this reason alone.

After adjustment of the nozzles with the help of at least one nozzle adjustment aid according to the invention, there were almost no further problems such as runners, strong pickling effects, white discolorations and reworking in this plant.

1. A nozzle adjustment aid (A) for a liquid spray nozzle (B) for testing, positioning, adjusting or a combination thereof the liquid spray nozzle (B) for spraying in surface engineering plants, characterized in that the nozzle adjustment aid (A) has one nozzle adapter (F) and at least two positioned and aligned light sources (H, M) with sharp bundling, with focusing or combinations thereof,
with the help of which at least two beams of light (J, P) can be produced approximately along a nozzle midline (D), approximately along at least one boundary line (R) at the edge of a theoretical spray range (C), approximately along at least two opposing boundary lines (R) or combinations thereof,
which indicate essentially the position and size of the theoretical spray range (C), which is visible in light spots on an object surface, hangers, conveyor devices, walls in the surface engineering plant or combinations thereof,
the angle formed by the beams of light (J, P) corresponds approximately to a half or whole of a theoretical spray angle (N, O) and the beams of light (J, P) are positioned in at least an essentially centrosymmetrical section through the theoretical spray range (C).

2. The nozzle adjustment aid according to claim 1, comprising a hand-held device.

3. The nozzle adjustment aid according to claim 1, consisting essentially of a base plate (E), nozzle adapter (F) and at least two light source adapters (HA, MA or combinations thereof) in particular with one light source (H or M) each per light source adapter (HA, MA or combinations thereof) and optionally also at least one abutment (Q) with at least one light source adapter (HA) with at least one light source (H) on the top, bottom or combinations thereof of the base plate (E), approximately in a plane of a mirror plane (G) or parallel to the mirror plane (G).

4. The nozzle adjustment aid according to claim 1, characterized in that the at least two beams of light (J, P) are produced with the at least two light sources (H, M), and at least two light spots are produced on surfaces opposite the nozzles, representing the at least one boundary line (R), at least one boundary point at a boundary of the theoretical spray range (C) and optionally also the nozzle midline (D) in a planar and essentially centrosymmetrical section through the theoretical spray range (C).

5. The nozzle adjustment aid according to claim 1, characterized in that with two light sources of the second type (M and M), two beams of light (P and P) are created essentially in a plane through the nozzle midline (D), causing two light spots to be visible on a surface opposite the liquid spray nozzle (B), representing boundary points of the theoretical spray range (C) in a planar and optionally essentially centrosymmetrical section through the theoretical spray range (C).

6. The nozzle adjustment aid according to claim 3, characterized in that the light source adapters (HA, MA or combinations thereof) of the light sources (H, M) are mounted, positioned and aligned on the base plate (E) at certain angle adjustments by means of conventional construction aid, positioning aids or combinations thereof.

7. The nozzle adjustment aid according to claim 3, characterized in that the light source adapters (HA, MA or combinations thereof) of the light sources (H, M) are sized so that more than two of them are affixed on the base plate (E) of the nozzle adjustment aid (A) at the same time.

8. The nozzle adjustment aid according to claim 3, characterized in that the light source adapters (HA, MA or combinations thereof) of the light sources of the second type (M) are arranged in pairs.

9. The nozzle adjustment aid according to claim 3, characterized in that the light source adapters (HA, MA or combinations thereof) of the light sources (H, M) are affixed in mirror symmetry around the nozzle midline (D), the mirror plane (G), the central beam of light (J) of the light source of the first type (H) or combinations thereof.

10. The nozzle adjustment aid according to claim 3, characterized in that the light source adapters (HA, MA or combinations thereof) of the light sources (H, M) are affixed by means of at least one first coaxial recess in the base plate (E) in comparison with a coaxial arrangement of boreholes, positioning aids, aids for angle alignment, at least one second recess in the base plate (E) to adjust the light sources (H, M) as continuously as possible for angles (N, O) of different sizes or combinations thereof, wherein an axis for the coaxial means runs essentially perpendicular to the base plate (E) through a central point Z, in the mirror plane (G) or combinations thereof.

11. The nozzle adjustment aid according to claim 1, further comprising at least one abutment (Q) approximately perpendicular to the base plate (E), approximately in the plane of the mirror plane (G) or parallel to the mirror plane (G), and at least one light source adapter with a light source on the top, bottom or combinations thereof of the base plate (E).

12. The nozzle adjustment aid according to claim 11, characterized in that a rigid carrier is mounted on at least one of the light source adapters to perform an angle adjustment and an accurate alignment by affixing the end of the rigid carrier at a central location on the nozzle adapter (F), of the liquid spray nozzle (B) or a combination thereof at the point of intersection of all angles (N, M).

13. A method for improving spraying in a surface engineering plant, characterized in that a nozzle adjustment aid (A) according to claim 1 is used for testing, positioning, adjusting or combinations thereof at least one liquid spray nozzle (B) in a surface engineering plant.

14. The method according to claim 13, characterized in that when testing, positioning, adjusting or combinations thereof, the at least one liquid spray nozzle (B), at least one nozzle holder with the at least one liquid spray nozzle (B) or combinations thereof, the nozzle midline (D), the distance from the nozzle opening to an object surface, the theoretical spray range (C), the actual spray range on sprayed object surfaces, the half angle (N) emanating laterally from the nozzle midline (D), the total angle (O) between at least two beams of light (J, P), an overlap of a spray range of a first nozzle with a spray range of at least one other nozzle are all improved.

15. A surface engineering plant with liquid spray nozzles (B), at least one nozzle holder with at least one liquid spray nozzle (B) or combinations thereof, which is at least partially improved by the nozzle adjustment aid (A) of claim 1.

16. (canceled)

17. Objects coated in the surface engineering plant of claim 15, wherein the objects are selected from products used in automotive engineering, architectural elements in construction, manufacturing equipment and machinery and combinations thereof.
